(19) United States
(12) Patent Application Publication
(10) Pub. No.: US 2007/0292190 A1
(43) Pub. Date: Dec. 20, 2007

(54) PLATEN AND PRINTER

(75) Inventors: Tsuneyuki Sasaki, Fukushima-ken (JP); Hirotoshi Terao, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/762,561

(22) Filed: Jun. 13, 2007

(30) Foreign Application Priority Data
Jun. 14, 2006 (JP) 2006-164864

(51) Int. Cl. B41J 11/00

(52) U.S. Cl. 400/656

(57) ABSTRACT

There is provided a platen and a printer pressed to printing elements with a uniform pressure, decreasing in size, reducing a force for transporting a printing medium, and smoothly transporting the printing medium. The platen includes a plurality of printing elements disposed parallel to a thermal head and a fixed platen disposed to be opposed to the printing elements. A convex portion that has a semicircular section is disposed in the portion of the platen pressed to printing elements so as to be opposed to the pressed portion in a linear shape.

This application claims the benefit of Japanese Patent Application No. 2006-164864, filed on Jun. 14, 2006, the entire contents of which is hereby incorporated by reference.

### BACKGROUND OF THE INVENTION

1. Field of the Invention

The present invention relates to a platen and a printer, and more particularly, to a fixed platen having a substantially plane-shaped top surface opposed to a printing element and a printer having the platen.

2. Description of the Related Art

In the known printers, a cylindrical platen, which is pressed to printing elements disposed parallel to a print head with a printing medium interposed therebetween and which is disposed so as to be rotatable, has been widely used for smoothly transporting the printing medium to a gap between the printing elements and the platen.

Recently, the printer has been desired to be smaller and thinner. In order to make the printer smaller and thinner, it has been contrived that parts of the printer become smaller. Thus, it has been contrived to reduce a diameter of the cylindrical platen to be rotatable.

However, as described above, when the diameter of the cylindrical platen is reduced, the rigidity of the platen is degraded. Accordingly, the center of the platen in a longitudinal direction thereof may be excessively curved. When the platen is excessively curved, the platen cannot be contacted with a uniform pressing force. As a result, a good quality image with a uniform concentration may not be printed on the printing medium. In addition, in order to solve the problem of the bending on the center of the platen, additional parts are required. Therefore, a cost of manufacturing the printer increases.

In order to solve the above-mentioned problem to make the printer smaller and thinner, it has been contrived to use a fixed platen having a semi-oval section and the surface opposed to the print head having a planar shape. An example of the related art is disclosed in JP-A-2001-293917.

The fixed platen described above has the substantially semi-oval section and the surface thereof has a planar shape. Accordingly, when the printing medium is transported to the gap between the platen and the printing element of the print head, the gap between the platen and the printing medium just before entering the printing medium into the gap therebetween is small. For the reason, the printing medium does not easily enter the gap between the platen and the printing medium pressed to each other with the pressing force. Consequently, the printing medium may not be smoothly transported.

In the fixed platen described above, the surface thereof has the planar shape and a width on the surface of the fixed platen in the same direction as a transport direction of the printing medium is larger than a width of the printing element in the same direction as the transport direction of the printing element. Accordingly, the contact area between the printing element and the platen becomes wider than that of a cylindrical rotating platen. As a result, since a large load is applied to the printing medium interposed between the printing element and the platen and the fixed platen does not rotate to transport the printing medium differently from the rotating platen, considerable driving power is required to transport the printing medium.

### SUMMARY OF THE INVENTION

The present invention has been made to solve the problem. An object of the invention is to provide a platen which is prevented from being bent so as to press the print head with the uniform pressing force, which has a small size, which smoothly transports the printing medium, and which reduces the force for transporting the printing medium and a printer having the platen.

In order to accomplish the above-mentioned object, there is provided a platen which is opposed to a print head so as to be pressed to the print head and is fixed in a printer, wherein a convex portion with a linear shape corresponding to the pressed portion to the print head is formed in the pressed portion.

According to the platen of the invention, since the convex portion is formed in a part pressed to the print head, a predetermined gap is secured between a pedestal supporting the convex portion and the print head just before the printing medium enters the gap between the convex portion and the print head. Accordingly, the printing medium smoothly enters the gap between the print head and the platen pressed to each other. In addition, since the convex portion is formed in the part pressed to the print head, the contact area between the print head and the platen can be made smaller than that of the known fixed platen having the planar top surface thereof for printing on the printing medium. Further, since the platen is fixed in the thermal printer, the center portion of the platen can be prevented from being bent in the longitudinal direction of the platen.

In another platen of the invention, the convex portion may project by 10 about μm or more, and a gap between a surface of a pedestal opposed to the print head and a surface of the print head opposed to the pedestal just before a printing medium enters the gap between the print head and the convex portion may be configured to have a size smaller than a thickness of the printing medium, in the state where the platen is pressed to the print head.

According to another platen of the invention, since the convex portion projects by 10 about μm or more, a predetermined gap is secured between the platen and the print head just before the printing medium enters the gap between the platen and the print head. Accordingly, since the printing medium smoothly enters the gap between the top surface of the convex portion and the surface of the print head, the printing medium can be smoothly transported.

Meanwhile, the convex portion is configured to project such that the gap between the surface of convex portion and the surface of the print head is configured to be smaller than the thickness of the printing medium just before the printing medium enters the gap between the print head and the convex portion in the state where the convex portion is pressed to the print head. Accordingly, a proper pressure can be applied to the printing medium just before the printing medium enters the gap between the print head and the convex portion. Consequently, the front end portion of the printing medium is arranged in order along the convex portion so as to enter the gap between the convex portion and the print head.

In another platen of the invention, the convex portion may have a semicircular section.

According to another platen of the invention, since the convex portion has a semicircular section and the top surface has a curved plane, the contact area of the print head and the platen may be made smaller than that of the known fixed platen.

In another platen of the invention, the convex portion may have a trapezoidal section and a width in the same direction as a transport direction of the printing medium to which a printing operation is performed may be formed to correspond to a width of the printing element having the print head in the same direction as the transport direction on the top surface of the convex portion opposed to the print head.

According to another platen of the invention, since the width of the top surface of the convex portion having the trapezoidal section view is formed to correspond to the width of the printing elements, the contact area of the print head and the platen may be made smaller than that of the known fixed platen.

In another platen of the invention, the platen may further include a pedestal supporting the convex portion, wherein the pedestal may include a platen base and a platen contactor disposed on a surface of the platen base opposed to the print head and the convex portion is formed on a surface of the platen contactor opposed to the print head.

According to another platen of the invention, since the convex portion is formed in the part pressed to the print head, a predetermined gap is secured between the platen contactor and the print head just before the printing medium enters the gap between the convex portion and the print head. Accordingly, the printing medium may smoothly enter the gap the print head and the platen.

In addition, since the convex portion is formed in the part pressed to the print head, a predetermined gap is secured between the platen base and the print head just before the printing medium enters the gap between the convex portion and the print head. Accordingly, the printing medium can smoothly enter the gap the print head and the platen.

In another platen of the invention, the platen further may include a pedestal supporting the convex portion, wherein the pedestal may include a platen base and the convex portion is formed on a surface of the platen base opposed to the print head.

In another platen of the invention, a thin film lowering the coefficient of friction between the printing medium and the surface opposed to the print head may be formed in the portion pressed to the printing medium on the surface in the course of transporting the printing medium.

According to another platen of the invention, since the tension to the printing medium interposed between the platen and the print head decreases by using the platen and the printing elements, the printing medium may be smoothly transported.

According to the invention, there is provided a printer including a printing element disposed parallel to a print head; a platen which is opposed to the printing element so as to be pressed to the printing element and is fixed; and a convex portion with a linear shape which corresponds to the pressed portion to the print head and which is formed in the pressed portion.

According to another platen of the invention, since the convex portion is formed, a predetermined gap is secured between the pedestal supporting the convex portion and the print head just before the printing medium enters the gap between the convex portion and the print head. Accordingly, the printing medium may smoothly enter the gap between the print head and the platen. Further, since the convex portion is formed in the part pressed to the print head, the contact area between the print head and the platen may be made smaller than that of the known fixed platen having the planar top surface thereof for printing on the printing medium. Further, since the platen is fixed in the thermal printer, the center portion of the platen can be prevented from being bent in the longitudinal direction of the platen.

In the platen and the printer according to the invention, the contact area of the print head and the platen can be made smaller than that of the known art. Accordingly, the load applied to the printing medium can be reduced by interposing the printing medium between the printing elements and the platen pressed to each other when the printing medium is transported to the gap between the print head and the platen. Further, since the pressing force between the printing elements and the platen is adjusted, the load applied to the printing medium can be adjusted. Accordingly, the printing medium can be smoothly transported by a transport roller with a small driving force.

In addition, since the platen is prevented from being bent, the print head is pressed to the platen with a uniform pressing force. Accordingly, a good quality image is printed with a uniform concentration. By using the fixed platen, the platen can be made small, and further, the printer can be made small and thin.

### BRIEF DESCRIPTION OF THE DRAWINGS

FIG. 1 is a schematic sectional view illustrating an embodiment of a printer using a platen according to the invention.

FIG. 2 is an enlarged sectional view illustrating the platen of FIG. 1.

FIG. 3 is a schematic perspective view illustrating the platen of FIG. 1.

FIG. 4 is a schematic sectional view illustrating another embodiment of a printer using a platen according to the invention.

### DESCRIPTION OF THE PREFERRED EMBODIMENT

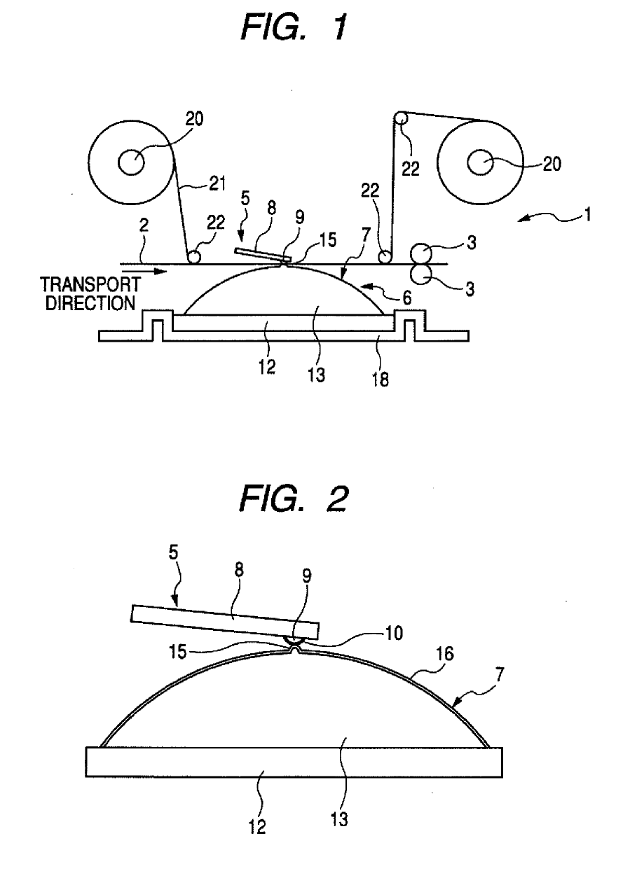

Hereinafter, an embodiment of a printer having a platen according to the invention will be described with reference to FIGS. 1 to 4. In the embodiment, a thermal printer having a thermal head as a print head is used as a printer, but the invention is not limited thereto and may be applied to various printers.

FIG. 1 is a schematic sectional view illustrating a thermal printer 1 as a printer according to the embodiment the invention. As shown in FIG. 1, in the thermal printer 1 according to the embodiment, a printing medium 2 is transported along a predetermined transport passage by a plurality of transport rollers 3.

In the thermal printer 1, a thermal head 5 and a platen 6 are disposed to be opposed to each other with the printing medium 2 interposed therebetween. The thermal head 5 presses on and is pressed to the platen 6.

As shown in FIG. 2, the thermal head 5 has a head base 8. A head contactor 9 having a substantially semicircular section is disposed on the surface of the head base 8 opposed to the platen 6. A height of the head contactor 9, for example, is formed in the range of about 50 to about 100 μm. On a surface of the head contactor 9 opposed to the platen, a plurality of printing elements 10 is disposed in parallel in a linear shape corresponding to a width perpendicular to the transport direction of the printing medium 2. Accordingly, the surfaces of the printing elements 10 opposed to the platen 6 are formed in a curved-surface shape.

The platen 6 has a pedestal 7. The pedestal 7 has a plane-shaped platen base 12 with a length corresponding to a width of the printing medium 2 and a platen contactor 13 which is disposed on a surface of the platen base 12 opposed to the thermal head 5, which has a substantially semicircular section, and which is made of a resin material. A part of the platen contactor 13 opposed to the thermal head 5 has a substantially planar shape. The platen contactor 13 is adhered to the platen base 12 by means such as a plating process.

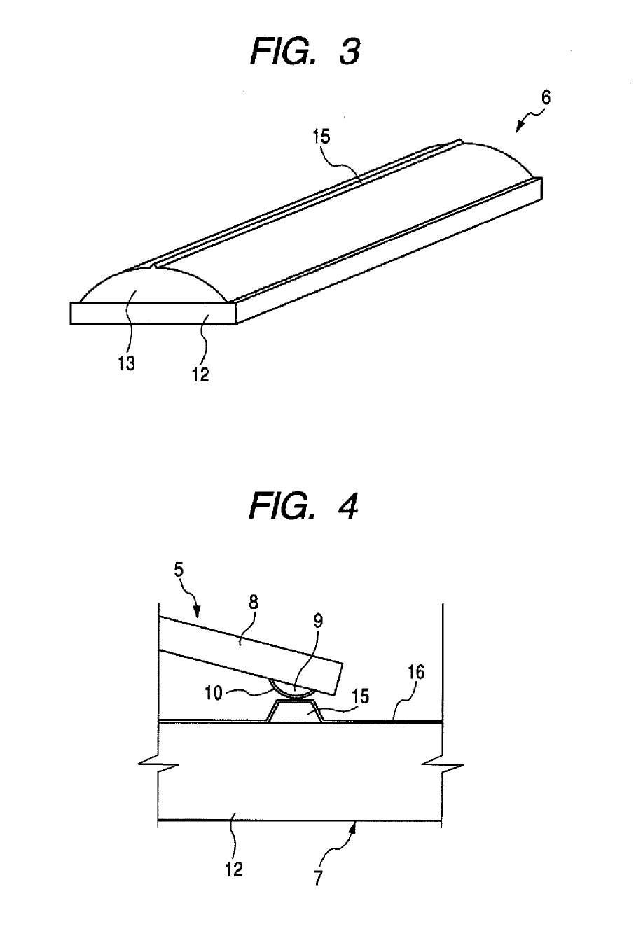

As shown in FIG. 3, in the pressed portion of the thermal head 5 to the printing elements 10 as the surface of the contactor 13 in the platen 6, a convex portion 15 projecting toward the thermal head 5 is formed to be integrated with the platen contactor 13. The convex portion 15 has a semicircular section. A surface of the convex portion 15 corresponding to the printing elements 10 has a curved-surface shape and is formed in a linear shape corresponding to the pressed portions of the printing elements 10. Accordingly, the printing elements 10 of the thermal head 5 are pressed to the top surface of the convex portion 15 of the platen 6.

It is preferable that a height of projecting from the base to the top portion in the convex portion 15 just before the printing medium 2 enters the gap between the printing elements 10 and the convex portion 15 is set such that a gap between the surface of the platen contactor 13 and the surface of the thermal head 5 is smaller than the thickness of the printing medium 2 in the pressed state to the printing elements 10. The convex portion 15 may project such that the gap between the base of the convex portion 15 and the base of the printing elements 10 is 10 μm. It is preferable that the convex portion 15 projects by about 10 μm.

A thin film 16 for reducing the coefficient of friction to the platen 6 is disposed on the top surface of the platen contactor 13 of the platen 6. The thin film 16 is adhered to the surface of the platen contactor 13 by an adhesive (not shown) such as a hot-melt sheet. The thin film may be made of materials for reducing the coefficient of friction. For example, FEP (tetrafluoro ethylene/hexafluoro propylene copolymer (tetrafluoride, hexafluoride)) or PTFE (polytetrafluoro ethylene (tetrafluoride)) may be used besides resin tetrafluoride. The thin film 16 is formed on the whole surface of the platen contactor 13 including the convex portion 15. In addition, in the state where the platen 6 is pressed to the printing elements 10, the thin film 16 may be formed in an area which is contacted on the surface of the platen 6 when the printing medium 2 enters the gap between the platen 6 and the thermal head 5. For example, in a thermal printer 1 capable of printing on the thickest printing medium 2 with 200 μm, the thin film 16 may be formed in a part on the surface of the platen 6 where the gap between the platen 6 and thermal head 5 is about 200 μm or less.

The platen base 12 of the platen 6 is mounted in a frame 18 of the thermal printer 1, whereby the platen 6 is fixed and disposed in the thermal printer 1.

The thermal printer 1 has a long ink ribbon 21 wound on a pair of ribbon rollers 20. While the ink ribbon 21 is guided by a plurality of guide rollers 22, the ink ribbon 21 is transported such that the ink-applied surface of the ink ribbon 21 is opposed to the printing medium 2.

The operation according to the embodiment will be described.

According to one embodiment, since the convex portion 15 is formed in a part of the thermal head 5 pressed to the printing elements 10, a predetermined gap is secured between the platen 6 and the thermal heads 5 just before the recording medium 2 enters the gap between the convex portion 15 and the printing elements 10. Accordingly, the printing medium 2 smoothly enters the gap between the printing elements 10 and the platen 6 pressed to each other.

Since the convex portion 15 of the platen 6 pressed to the printing elements 10 of the thermal head 5 has a semicircular section, the contact area between the printing elements 10 and the platen 6 is made to be smaller than that of the known fixed platen 6.

Since the platen 6 is fixed in the thermal printer 1, the center portion of the platen 6 in the longitudinal direction of the platen 6 can be prevented from being bent.

The predetermined gap between the platen 6 and the thermal head 5 opposed to each other is secured just before the printing medium 2 enters the gap between the convex portion 15 and the printing elements 10. Accordingly, the printing medium 2 more easily enters the gap between the convex portion 15 and the printing elements 10, thereby smoothly transporting the printing medium 2. Since the printing medium 2 smoothly enters the gape between the printing elements 10 and the convex portion 15, the printing operation can be performed from the front end of the printing medium 2. Therefore, the platen 6 can be suitable for printing without a margin as well.

Since the contact area between the printing elements 10 and the platen 6 can be reduced, it is possible to reduce the load applied to the printing medium 2 interposed between the printing elements 10 and the platen 6. In addition, the pressing force between the printing elements 10 and platen 6 is adjusted so as to adjust the load applied to the printing medium 2. Accordingly, the printing medium 2 can be smoothly transported with the small driving power.

Since the platen 6 is prevented from being bent, the printing elements 10 press the platen 6 with the uniform pressure. Accordingly, the good quality image can be printed with the uniform concentration. By using the fixed platen 6, the platen 6 can be allowed to be small in size, and further the printer can become smaller and thinner in size.

The convex portion 15 is configured to project such that the gap between the base of the convex portion 15 and the base of the heat-emitting elements is about 10 μm or more and the convex portion 15 is configured to project by about 10 μm. Accordingly, the gap can be reliably secured between the platen 6 and the printing elements 10 just before the printing medium 2 enters the gap between the convex portion 15 and the printing elements 10. In this manner, since the printing medium 2 easily enters the gap between the convex portion 15 of the platen 6, the printing medium 2 can be smoothly transported.

Meanwhile, the convex portion 15 is configured to project such that the gap between the surface opposed to the printing elements 10 and the surface of the thermal head 5 is configured to be smaller than the thickness of the printing medium 2 just before the printing medium 2 enters the gap between the printing elements 10 and the convex portion 15 in the state where the convex portion 15 is pressed to the printing elements 10, thereby applying a pressure suitable for the printing medium 2 just before the printing medium 2 enters the gap between the printing elements 10 and the convex portion 15. In this manner, the front end portion of the printing medium 2 is arranged in order along the convex portion 15 so as to enter the gap between the convex portion 15 and the print head.

On the surface of the platen contactor 13 of the platen 6, the thin film 16 for decreasing the coefficient of friction between the platen 6 and the printing elements 10 is formed in the portion pressed to the surface of the platen 6 when the printing medium 2 enters the gap between the platen 6 and the printing elements 10 in the state where the platen 6 and the printing elements 10 contact to each other. Accordingly, it is possible to reduce the tension to printing medium 2 interposed between the platen 6 and the printing elements 10 due to the platen 6 and the printing elements 10, thereby further smoothly transporting the recording medium 2. When the printing medium 2 is not positioned in the gap between the platen 6 and the printing elements 10 and the platen 6 and the printing elements 10 are pressed to each other with the ink ribbon interposed therebetween, the ink ribbon can be prevented from being attached to the platen 6.

A second embodiment of a printer using the platen 6 according to the invention will be described. Herein, in the second printer, the detail description of the same configuration as the first printer is omitted and the same reference numerals as the first embodiment are used in the second embodiment.

FIG. 4 is a schematic sectional view illustrating a printer according to the second embodiment. As shown in FIG. 4, a platen 6 of the printer according to the second embodiment has a pedestal 7 including a platen base 12 with a planar shape.

A convex portion 15 which projects toward the thermal head 5 and which is made of a resin material is formed on a part pressed to the printing elements 10 of the thermal head 5 on the surface of the platen base 12. The convex portion 15 has a trapezoidal section and has a linear shape corresponding to the printing elements 10. A width on the top surface of the convex portion 15 opposed to the printing elements 10 in the same direction as the transport direction of the printing medium 2 corresponds to a width of the printing elements 10 in the same direction as the transport direction of the printing medium 2. It is preferable that the width of the top surface of the convex portion 15 is smaller than that of the printing elements 10 and may be in the range of the about 100 to about 200 μm.

A thin film 16 for reducing the coefficient of friction of the printing medium 2 to the platen 6 is disposed on the surface of the platen 6, that is, the surface of the convex portion 15 and the platen base 12.

The platen base 12 is attached to the frame 18 of the thermal printer 1 such that the platen 6 is fixed in the thermal printer 1.

Next, the operation of the second embodiment will be described.

According to the second embodiment, since the convex portion 15 is formed in the part pressed to the printing elements 10 of the thermal head 5, a predetermined gap can be secured between the platen 6 and the thermal head 5 just before the printing medium 2 enters the gap between the convex portion 15 and the printing elements 10. In this manner, the printing medium 2 smoothly enters the gap between the printing elements 10 and the platen 6 pressed to each other.

The printing elements 10 of the thermal head 5 is pressed to the convex portion 15 of the platen 6, the convex portion 15 has the trapezoidal section, and the width of the top surface of the convex portion 15 is formed in the range of about 100 to about 200 μm. Accordingly, when the printing operation is performed to the printing medium 2, the contact area between the printing elements 10 and the platen 6 can be made smaller than that of the known fixed platen 6.

In addition, since the platen 6 is fixed in the thermal printer 1, the center of the platen 6 in the longitudinal direction of the platen 6 is prevented from being bent.

Since the predetermined gap between the platen 6 and the thermal head 5 opposed to each other is secured just before the printing medium 2 enters the gap between the convex portion 15 and the printing elements 10, the printing medium 2 more easily enters the gap between the convex portion 15 and the printing medium 2, thereby smoothly transporting the printing medium 2. Since the printing medium 2 more easily enters the gap between the printing elements 10 and the convex portion 15, the printing operation can be performed from the front end of the printing medium 2. Accordingly, it is suitable for printing without a margin as well.

In addition, since the contact area between the printing elements 10 and the platen 6 can be made small, it is possible to reduce the load applied to the printing medium 2 interposed between the printing elements 10 and the platen 6 pressed to each other. In this manner, the printing medium 2 is smoothly transported by the transport roller 3 with the small driving power.

Since the platen 6 is prevented from being bent, the printing elements 10 presses on the platen 6 with the uniform pressing force. Accordingly, the image with the uniform concentration is printed. Since this fixed platen 6 is used, the platen 6 may have a smaller size and further the printer may have a smaller and thinner size.

According to the platen 6 of the second embodiment, since the convex portion 15 is formed on the surface of the platen base 12, the platen 6 may become thinner and smaller. In addition, materials forming the platen 6 may not be omitted, thereby decreasing the cost of manufacturing the platen 6.

The invention is not limited to the embodiments disclosed herein and may be variously modified if necessary.

For example, in the embodiments, the surface of the printing elements 10 has a curved shape. However, it is not limited thereto and the surface may have a planar shape. That is, even when the surface of the printing elements 10 has the planar shape, the contact area between the printing elements 10 and the platen 6 can be made smaller by using the platen 6 of the invention having the convex portion 15 on the platen 6. Accordingly, the head contactor 9 for forming the surface of the printing elements 10 in the curved shape may not be necessary, thereby decreasing the cost of manufacturing the platen 6, simplifying the process of manufacturing same, and decreasing the size and the thickness of the thermal head 5. Further, the printer 1 can be made smaller and thinner. Since the surface of the printing elements 10 is formed in the planar shape, thereby preventing the platen 6 from being recessed by the press and contact between the printing elements 10 and the platen 6.

The shape of the platen 6 is not limited to the embodiments disclosed herein. For example, in the platen 6, the convex portion 15 with a trapezoidal section may be formed on the surface of the contactor 13 with a semicircular shape. In addition, the convex portion 15 with a semicircular section may be formed on the surface of the platen base 12.

The embodiments are described by using the line-thermal printer 1 in which the plurality of printing elements 10 are disposed in a linear shape corresponding to the width of the printing medium 2, but the present invention is not limited thereto.

What is claimed is:

1. A platen that is opposed to a print head so as to be pressed to the print head and is fixed in a printer, wherein a convex portion with a shape corresponding to a pressed portion to the print head is disposed in the pressed portion.

2. The platen according to claim 1, wherein the convex portion projects by about 10 μm or more, and a gap between a surface of a pedestal opposed to the print head and a surface of the print head opposed to the pedestal just before a printing medium enters the gap between the print head and the convex portion is configured to have a size smaller than a thickness of the printing medium in the state where the platen is pressed to the print head.

3. The platen according to claim 1, wherein the convex portion has a semicircular section.

4. The platen according to claim 1, wherein the convex portion has a trapezoidal section.

5. The platen according to claim 4, wherein the convex portion has a width substantially in the same direction as a transport direction of the printing medium to which a printing operation is performed, the convex portion being formed to correspond to a width of the printing element that has the print head substantially in the same direction as the transport direction on the top surface of the convex portion opposed to the print head.

6. The platen according to claim 1, further comprising a pedestal that supports the convex portion, wherein the pedestal includes a platen base and a platen contactor disposed on a surface of the platen base opposed to the print head and the convex portion is disposed on a surface of the platen contactor opposed to the print head.

7. The platen according to claim 1, further comprising a pedestal that supports the convex portion, wherein the pedestal includes a platen base and the convex portion is disposed on a surface of the platen base opposed to the print head.

8. The platen according to claim 1, wherein a thin film that lowers the coefficient of friction between the printing medium and the surface opposed to the print head is disposed in the portion pressed to the printing medium on the surface in the course of transporting the printing medium.

9. The platen according to claim 1, wherein the shape corresponding to the pressed portion to the print head is linear.

10. A printer comprising:
a printing element disposed parallel to a print head;
a platen that is opposed to the printing element so as to be pressed to the printing element and is fixed; and
a convex portion with a linear shape corresponding to a pressed portion to the print head and disposed in the pressed portion.

11. The printer according to claim 10, wherein the convex portion projects by about 10 μm or more, and a gap between a surface of a pedestal opposed to the print head and a surface of the print head opposed to the pedestal just before a printing medium enters the gap between the print head and the convex portion is configured to have a size smaller than a thickness of the printing medium in the state where the platen is pressed to the print head.

12. The printer according to claim 10, wherein the convex portion has a semicircular section.

13. The printer according to claim 10, wherein the convex portion has a trapezoidal section.

14. The printer according to claim 13, wherein the convex portion has a width substantially in the same direction as a transport direction of the printing medium to which a printing operation is performed, the convex portion being formed to correspond to a width of the printing element that has the print head substantially in the same direction as the transport direction on the top surface of the convex portion opposed to the print head.

15. The printer according to claim 10, further comprising a pedestal that supports the convex portion, wherein the pedestal includes a platen base and a platen contactor disposed on a surface of the platen base opposed to the print head and the convex portion is disposed on a surface of the platen contactor opposed to the print head.

16. The printer according to claim 10, further comprising a pedestal that supports the convex portion, wherein the pedestal includes a platen base and the convex portion is disposed on a surface of the platen base opposed to the print head.

17. The printer according to claim 10, wherein a thin film that lowers the coefficient of friction between the printing medium and the surface opposed to the print head is disposed in the portion pressed to the printing medium on the surface in the course of transporting the printing medium.

18. The printer according to claim 10, wherein the shape corresponding to the pressed portion to the print head is linear.
